(19) United States
(12) Patent Application Publication
(10) Pub. No.: US 2021/0220225 A1
(43) Pub. Date: Jul. 22, 2021

(54) CONTAINER HAVING FUNCTION REPLACING MODULE

(71) Applicant: K-Jump Health Co., Ltd., New Taipei City (TW)

(72) Inventor: Chao-Man TSENG, New Taipei City (TW)

(21) Appl. No.: 16/814,996

(22) Filed: Mar. 11, 2020

(30) Foreign Application Priority Data
Jan. 17, 2020 (TW) 109101739

(51) Int. Cl. A61J 11/00; A61J 9/00

(52) U.S. Cl. CPC A61J 11/002; A61J 9/008; A61J 11/0005

(57) ABSTRACT

A container having a function replacing module includes: a storing main body (1), having a bottom part (10) and a lateral part (11) upwardly extended from the bottom part (10) so as to surrounding the bottom part (10); and a function module (2), disposed at the bottom part (10) of the storing main body (1); wherein, a connecting part (101) is disposed at the bottom part (10) of the storing main body (1), the function module (2) has a carrying part (20), a fitting part (21) allowing the carrying part (20) to be assembled at the bottom part (10) of the storing main body (1), and a function unit (22, 23, 24) disposed on the carrying part (20), and the fitting part (21) is combined with the connecting part (101) with a detachable means. Accordingly, an objective of replacing the function module (2) can be achieved.

### BACKGROUND OF THE INVENTION

### Field of the Invention

The present invention relates to a container, especially to a container having a function replacing module, which is suitable to be applied as a feeding bottle.

### Description of Related Art

A conventional container, for example a water bottle or a feeding bottle used for storing liquid, is provided with functions of storing and accommodating, and for different operating occasions, other corresponding functions are also provided for increasing the utility benefits of a product. For example, the above-mentioned feeding bottle is not only provided with a function of accommodating milk used for feeding an infant, an anti-bloating function is also designed for avoiding a situation of the infant feeling bloated when he/she is drinking.

However, in the additional functions provided to different types of a container, only one function is provided, if a user wants to have other functions, other products having the desired functions need to be purchased. As such, a functional product capable of replacing its function according to the user's operating status cannot be provided, thereby causing the operation inconveniences. Meanwhile, for the manufacturer, additional molds and production lines have to be made correspondingly to meet different functions, so that the production cost will inevitably increase.

Accordingly, the applicant of the present invention has devoted himself for improving the mentioned disadvantages.

### SUMMARY OF THE INVENTION

The present invention is to provide a container having a function replacing module, which can be used for replacing a function module corresponding to a desired function according to an actual need so as to satisfy an operating requirement.

Accordingly, the present invention provides a container having a function replacing module, which includes a storing main body and a function module, the storing main body has a bottom part and a lateral part upwardly extended from the bottom part so as to surrounding the bottom part, and the function module is disposed at the bottom part of the storing main body, wherein a connecting part is disposed at the bottom part of the storing main body, the function module has a carrying part, a fitting part allowing the carrying part to be assembled at the bottom part of the storing main body, and a function unit disposed on the carrying part; and the fitting part is combined with the connecting part with a detachable means.

### BRIEF DESCRIPTION OF DRAWING

FIG. 1 is a perspective view showing an appearance according to the present invention;

FIG. 2 is a perspective exploded view according to the present invention;

FIG. 3 is a perspective exploded view showing the function module according to a first embodiment of the present invention;

FIG. 4 is another perspective exploded view showing the function module according to the first embodiment of the present invention;

FIG. 5 is a cross sectional view showing the function module being disposed on the storing main body according to the first embodiment of the present invention;

FIG. 6 is a schematic view showing an operating status of the function module according to the first embodiment of the present invention;

FIG. 7 is a perspective exploded view showing the function module according to a second embodiment of the present invention;

FIG. 8 is another perspective exploded view showing the function module according to the second embodiment of the present invention;

FIG. 9 is a schematic view showing an operating status of the function module according to the second embodiment of the present invention; and

FIG. 10 is a schematic view showing an operating status of the function module according to a third embodiment of the present invention.

### DETAILED DESCRIPTION OF THE INVENTION

Preferred embodiments of the present invention will be described with reference to the drawings.

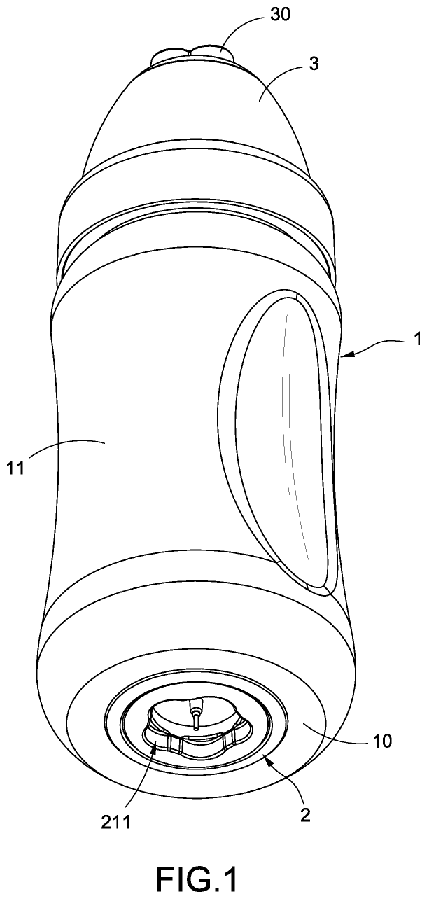

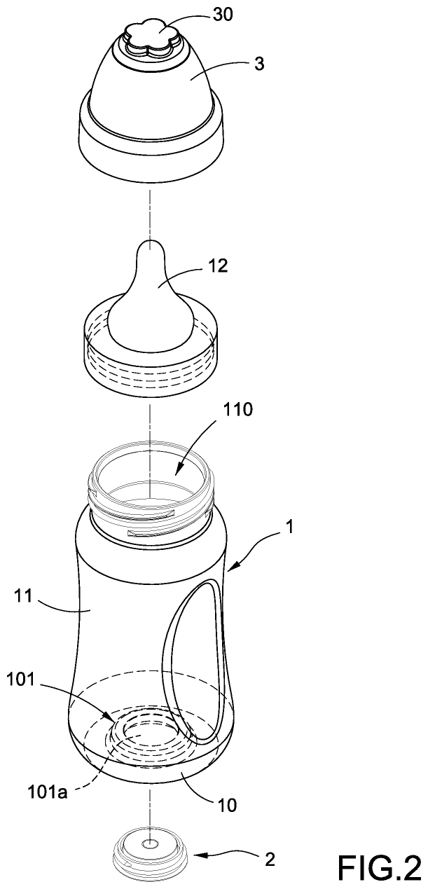

Please refer to FIG. 1 and FIG. 2, wherein FIG. 1 is a perspective view showing an appearance according to the present invention; and FIG. 2 is a perspective exploded view according to the present invention. The present invention provides a container having a function replacing module. The container can be various types of appliances having a storing function, in other words the container at least includes a storing main body 1. According to one embodiment of the present invention, the container can be a feeding bottle. The feeding bottle includes the above-mentioned storing main body 1, and a function module 2 disposed at a bottom end of the storing main body 1.

The storing main body 1 has a bottom part 10, and a lateral part 11 upwardly extending from the bottom part 10 so as to surround the bottom part 10, and an opening 110 is formed in the lateral part 11, so that a space jointly defined by the bottom part 10 and the lateral part 11 can be used for accommodating or storing objects. A pacifier 12 can be disposed at the opening 110 of the storing main body 1, thereby forming as the feeding bottle. A bottle cover 3 can be further provided at an outer side of the pacifier 12, and the bottle cover 3 can also be disposed on the storing main body 1 for sealing the opening 110, or be provided at the outer side of the pacifier 12.

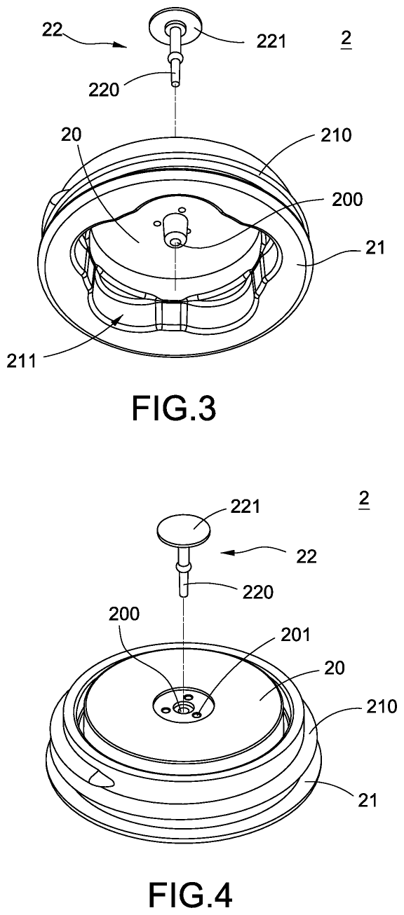

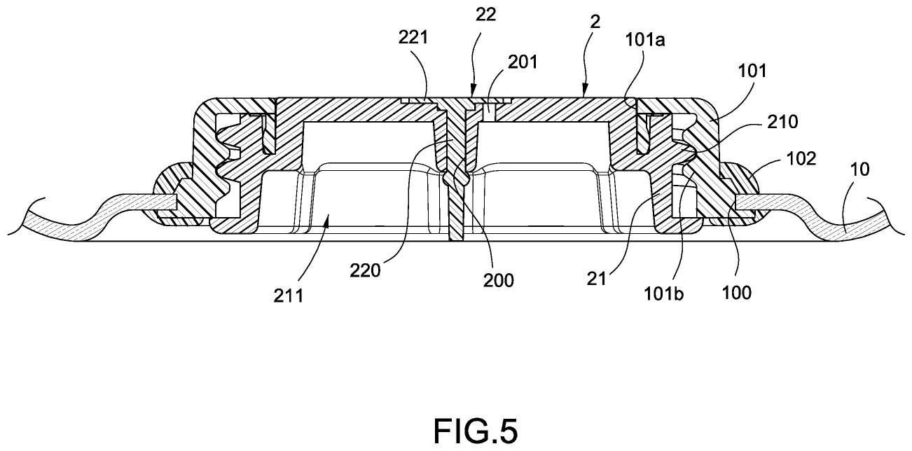

The function module 2 is disposed at the bottom part 10 of the storing main body 1, and the function module 2 having different functions can be replaced or integrated. Please refer to FIG. 3 and FIG. 4, the function module 2 mainly has a carrying part 20, a fitting part 21 allowing the carrying part 20 to be assembled at the bottom part 10 of the storing main body 1, and a function member 22 disposed on the carrying part 20. Meanwhile, please refer to FIG. 5, an assembling hole 110 is formed at the bottom part 10 of the storing main body 1, a connecting part 101 is disposed in the assembling hole 110, a waterproof ring 102 used for sealing is disposed between the connecting part 101 and the assembling hole 100, and a connecting hole 101a allowing the carrying part 20 to be sealed is formed on the connecting part 101.

Based on what has been disclosed above, according to this embodiment of the present invention, the storing main body 1 has inner threads 101b in the connecting part 101, and the function module 2 has outer threads 210 at an outer side of the fitting part 21, so that the outer threads 210 of the fitting part 21 can be threaded and connected to the inner threads 101b of the connecting part 101 for being tight (tightly [symbol] ) in contact, thereby enabling the function module 2 to be assembled at the bottom part 10 of the storing main body 1, meanwhile the function module 2 can be properly detached for replacement according to actual needs. Moreover, an engaging part 30 is disposed on the bottle cover 3, and an engaging hole 211 is formed at a bottom end of the function module 2, the engaging hole 211 can be arranged at a lower portion of the fitting part 21. The engaging part 30 can be formed in a flower-like shape, and the engaging hole 211 having a matched shape can be engaged with the engaging part 30, so that the bottle cover 3 is able to rotate the function module 2 for being served as an auxiliary tool for detaching or assembling.

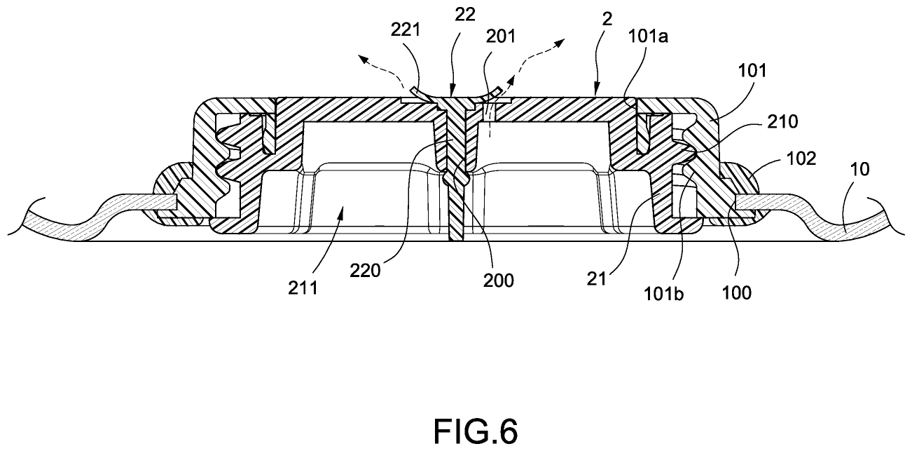

As such, according to the first embodiment of the present invention, and as shown from FIG. 3 to FIG. 5, the function member 22 of the function module 2 is an air valve which is used for providing anti-bloating function to the feeding bottle. The air valve has a valve rod 220 and a valve cover 221, the valve cover 221 is made of a soft plastic material, the carrying part 20 of the function module 2 has a fastening hole 200 allowing the valve rod 220 to pass and be fastened therein, and a valve hole 201 blocked by the valve cover 221; please refer to FIG. 6, when the feeding bottle is in use (an infant uses the pacifier 12), external air is able to partially push a lateral side of the valve cover 221, and the external air is allowed to pass the valve hole 201 and enter the storing main body 1 from the bottom part 10 of the storing main body 1, so that a situation of the infant having a bloating feeling can be avoided.

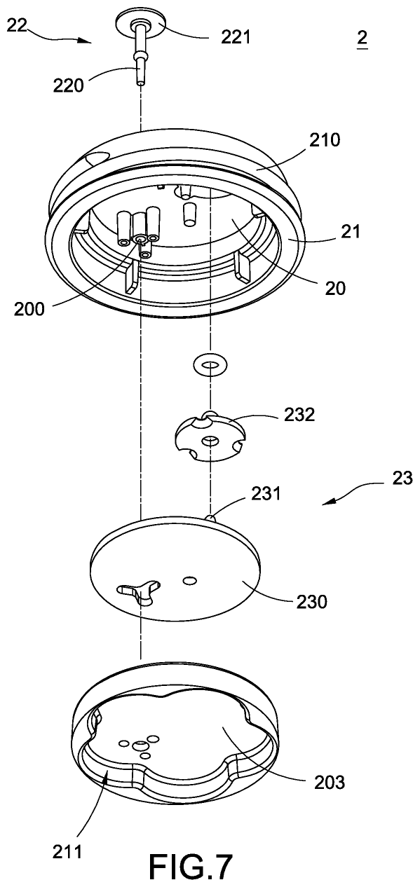

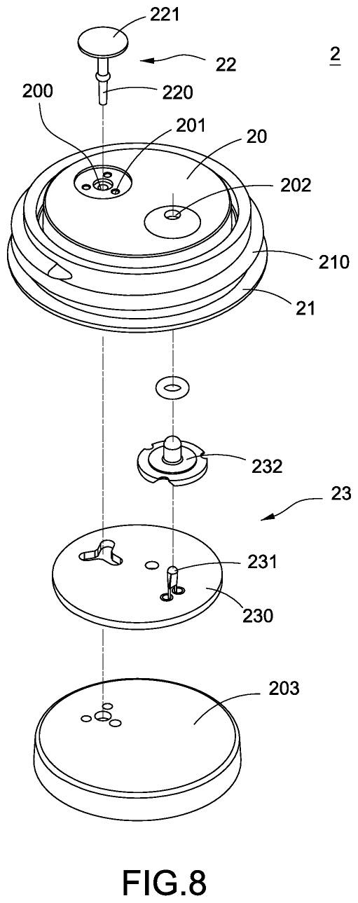

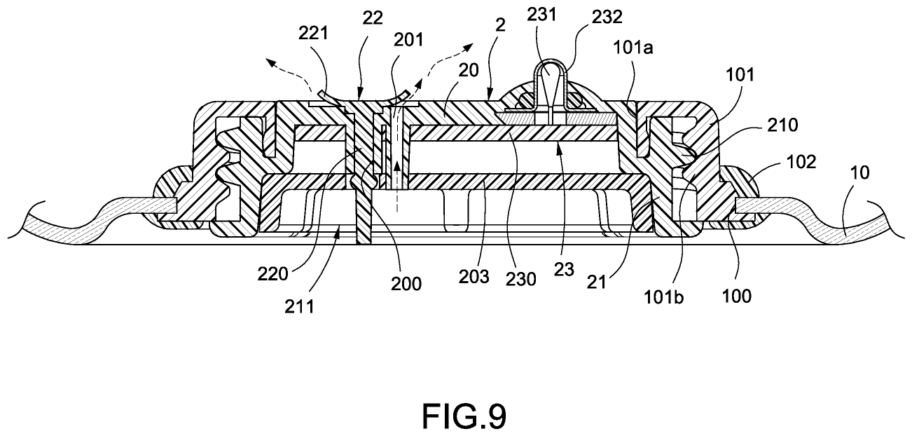

Please refer to FIG. 7 and FIG. 8, and according to a second embodiment of the present invention, the function module 2 has the function member 22 and another function member 23, which are the above-mentioned air valve and a temperature sensor and both disposed on the carrying part 20. Wherein, the air valve is the same as the air valve disclosed in the first embodiment, therefore no further illustration is provided. The temperature sensor has a control circuit board 230 and a temperature sensing unit 231 disposed on the control circuit board 230. The temperature sensing unit 231 is allowed to pass a temperature sensing hole 202 of the carrying part 20, a waterproof component 232 is provided for enclosing the temperature sensing unit 231, and a cover plate 203 is disposed at a rear end of the control circuit board 230. Please refer to FIG. 9, the feeding bottle is not only provided with the anti-bloating function, the function member 23, which is the temperature sensor, can be used for sensing a temperature of the milk to be fed, so that an electric controlling means, for example being provided with a chip, can be utilized for determining whether a current temperature of the milk is suitable for being drinking by the infant, or a temperature displaying means can be provided to tell the current temperature of the milk.

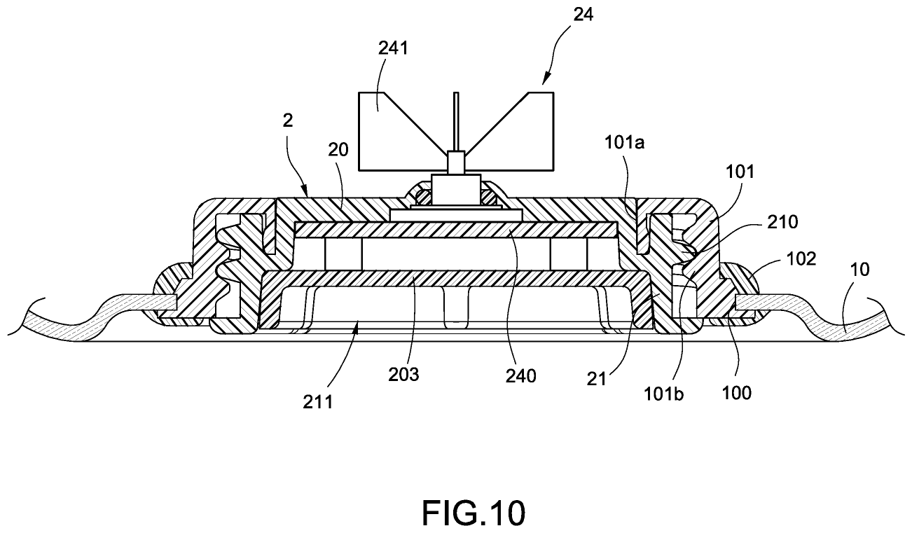

Please refer to FIG. 10 and according to a third embodiment of the present invention, the function module 2 has a function member 24, which as a stirrer, a control circuit board 240 having the stirrer is provided, and a blade wheel 241 disposed on the control circuit board 240 is also provided. The blade wheel 241 can be driven to rotate by a power source, for example a motor, so that the milk inside the storing main body 1 can be stirred, thereby providing an automatic stirring function.

Based on what has been mentioned above, with the above-mentioned components, the container having the function replacing module is provided.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A container having a function replacing module, including:
a storing main body (1), having a bottom part (10) and a lateral part (11) upwardly extended from the bottom part (10) so as to surrounding the bottom part (10), and
a function module (2), disposed at the bottom part (10) of the storing main body (1);
wherein, a connecting part (101) is disposed at the bottom part (10) of the storing main body (1), the function module (2) has a carrying part (20), a fitting part (21) allowing the carrying part (20) to be assembled at the bottom part (10) of the storing main body (1), and a function unit (22, 23, 24) disposed on the carrying part (20), and the fitting part (21) is combined with the connecting part (101) with a detachable means.

2. The container having the function replacing module according to claim 1, wherein an opening (110) is formed in the lateral part (11) of the storing main body (1), and a pacifier (12) is disposed at the opening (110), thereby forming as the feeding bottle

3. The container having the function replacing module according to claim 1, wherein a bottle cover (3) is disposed on the storing main body (1), an engaging part (30) is disposed on the bottle cover (3), and an engaging hole (211) having a matched shape with a shape of the engaging part (30) for being mutually engaged is formed at a bottom end of the function module (2).

4. The container having the function replacing module according to claim 1, wherein an assembling hole (100) is formed at the bottom part (10) of the storing main body (1), the connecting part (101) is disposed in the assembling hole (100), and a waterproof ring (102) is disposed between the connecting part (101) and the assembling hole (100) for a purpose of sealing.

5. The container having the function replacing module according to claim 1, wherein the storing main body (1) has inner threads (101b) in the connecting part (101), and the function module (2) has matched outer threads at an outer side of the fitting part (21).

6. The container having the function replacing module according to claim 1, wherein the function module (2) is an air valve, which has a valve rod (220) and a valve cover (221), and the carrying part (20) of the function module (2) has a fastening hole (200) allowing the valve rod (220) to pass and be fastened therein, and a valve hole (201) blocked by the valve cover (221).

7. The container having the function replacing module according to claim 6, wherein the valve cover (221) is made of a soft plastic material.

8. The container having the function replacing module according to claim 1, wherein the function member (23) is a temperature sensor, which has a control circuit board (230) and a temperature sensing unit (231) disposed on the control circuit board (230), the temperature sensing unit (231) is allowed to pass a temperature sensing hole (202) of the carrying part (20), a waterproof component (232) is provided for enclosing the temperature sensing unit (231), and a cover plate (203) is disposed at a rear end of the control circuit board (230).

9. The container having the function replacing module according to claim 1, wherein the function member (24) is a stirrer, and has a control circuit board (240) and a blade wheel (241) disposed on the control circuit board (240).

10. The container having the function replacing module according to claim 1, wherein there are a plurality of the function members (22, 23, 24).
